(19) United States
(12) Patent Application Publication
(10) Pub. No.: US 2015/0131257 A1
(43) Pub. Date: May 14, 2015

(54) STROBE DEVICE AND IMAGING DEVICE EQUIPPED WITH SROBE DEVICE

(71) Applicant: Panasonic Intellectural Property Management Co., Ltd., Osaka (JP)

(72) Inventor: Minenori Kaimoto, Osaka (JP)

(73) Assignee: Panasonic Intellectural Property Management Co., Ltd., Osaka (JP)

(21) Appl. No.: 14/395,536

(22) PCT Filed: Apr. 18, 2013
(86) PCT No.: PCT/JP2013/002613

§ 371 Date: Oct. 20, 2014

(30) Foreign Application Priority Data
Apr. 25, 2012 (JP) 2012-099475

(51) Int. Cl. G03B 15/05

(52) U.S. Cl. CPC G03B 15/05
USPC 362/5

(57) ABSTRACT

A strobe device according to the present invention includes: a strobe main body; a light-emitting unit rotatably connected to the strobe main body; a variable mechanism capable of changing an angle of the light-emitting unit; a drive unit for driving the variable mechanism; and a control unit for controlling the drive unit, wherein the control unit has a mode of changing an illumination direction angle of the light-emitting unit at each shot in a continuous shooting operation. This realizes a strobe device that makes it possible to immediately obtain a favorite image.

This application is a U.S. National Phase Application of PCT International Application PCT/JP2013/002613.

### TECHNICAL FIELD

This invention relates to a strobe device which can change an illumination direction of a light-emitting unit (variable illumination direction type strobe device) and to an imaging device equipped with the strobe device.

### BACKGROUND ART

In the past, such an imaging device has been proposed that performs a bounce flash shooting, in which a subject to be photographed is indirectly illuminated by diffused light obtained by reflecting strobe light emitted from a light-emitting unit of a strobe device with a reflective body such, for example, as a ceiling or wall, to obtain a more natural image (see, for example, PTL 1 of Patent Literature).

That is, in the bounce flash shooting, a light-emitting plane of the light-emitting unit of the strobe device is not directly faced to the subject, but is faced toward a desired direction in which a reflective body such as a ceiling or a wall exists so that the subject is illuminated by the strobe light reflected by the reflective body and photographed under this illumination condition.

In the strobe device disclosed in PTL1, however, the direction of the light-emitting unit must be manually set by a photographer. Therefore, if a desired image is not obtained, it is necessary to readjust the direction of the light-emitting unit and try another shooting again. These works must be repeated continuously until a desired image is obtained.

Accordingly, the conventional strobe device has such problems that it takes time to take a photograph, and that the best shot may occasionally be missed.

### CITATION LIST

### Patent Literature

PTL 1: Unexamined Japanese Patent Publication No. H08-76201

### SUMMARY OF THE INVENTION

To solve the above problems, a strobe device according to the present invention includes: a strobe main body; a light-emitting unit rotatably connected to the strobe main body; a variable mechanism capable of changing an angle of the light-emitting unit; a drive unit for driving the variable mechanism; and a control unit for controlling the drive unit, wherein the control unit has a mode of changing an illumination direction angle of the light-emitting unit at each shot in a continuous shooting operation.

This strobe device makes it possible to obtain a plurality of images taken in nearly a same state of a subject under different strobe illumination conditions during continuous shooting of the subject. As a result, a photographer can easily obtain a favorite image from the plurality of images, such, for example, as an image in which effects of the bounce flash shooting appear remarkably. Further, the photographer can obtain preferable strobe illumination conditions.

Also, an imaging device according to the present invention is equipped with the above-described strobe device. This makes it possible to realize an imaging device that can easily obtain a plurality of images taken under different strobe illumination conditions.

### BRIEF DESCRIPTION OF DRAWINGS

FIG. 1 is a block diagram showing a configuration of an imaging device according to an exemplary embodiment of the present invention.

FIG. 2 is a side view of the strobe device according to the exemplary embodiment.

FIG. 3 is a top view of the strobe device according to the exemplary embodiment.

FIG. 4A is a diagram illustrating an illumination range in a vertical direction, which can be set by the strobe device according to the exemplary embodiment.

FIG. 4B is a diagram illustrating an illumination range in a horizontal direction, which can be set by the strobe device according to the exemplary embodiment.

FIG. 5A is a conceptual diagram showing an example of continuous light emission pattern by the strobe device according to the exemplary embodiment.

FIG. 5B is a conceptual diagram showing an example of continuous light emission pattern by the strobe device according to the exemplary embodiment.

FIG. 5C is a conceptual diagram showing an example of continuous light emission pattern by the strobe device according to the exemplary embodiment.

FIG. 5D is a conceptual diagram showing an example of continuous light emission pattern by the strobe device according to the exemplary embodiment.

FIG. 5E is a conceptual diagram showing an example of continuous light emission pattern by the strobe device according to the exemplary embodiment.

FIG. 6 is a flowchart illustrating operations in a continuous shooting mode by the strobe device according to the exemplary embodiment.

### DESCRIPTION OF EMBODIMENT

Hereinafter, a strobe device according to an exemplary embodiment of the present invention and an imaging device equipped with the same will be described with reference to the drawings. It should be noted that the exemplary embodiment described below is an embodied example of the present invention, and is not intended to limit the technical scope of the present invention.

### Exemplary Embodiment

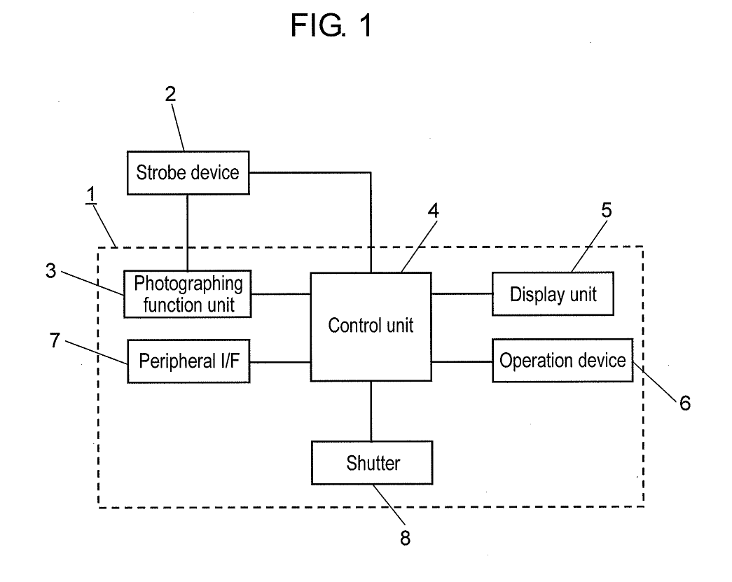

Hereinafter, a strobe device according to an exemplary embodiment of the present invention and an imaging device equipped with the strobe device will be described with reference to FIG. 1 to FIG. 4B.

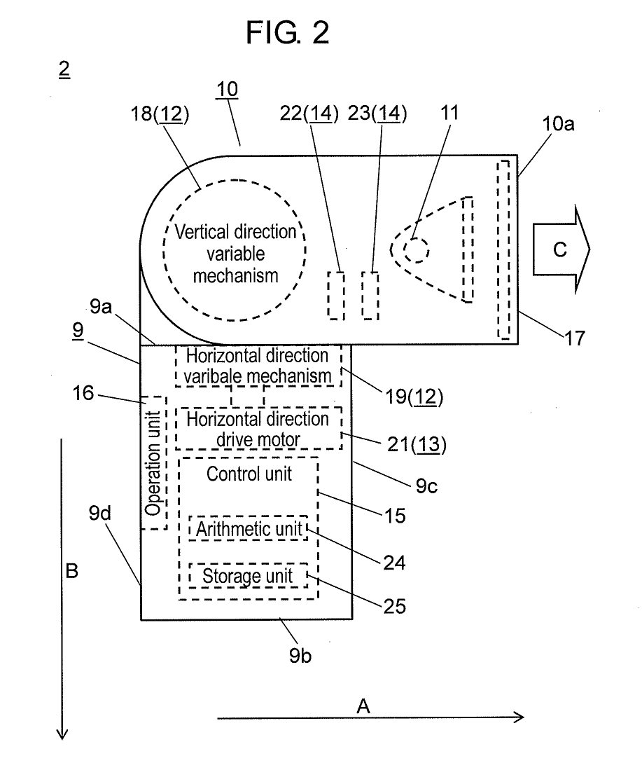

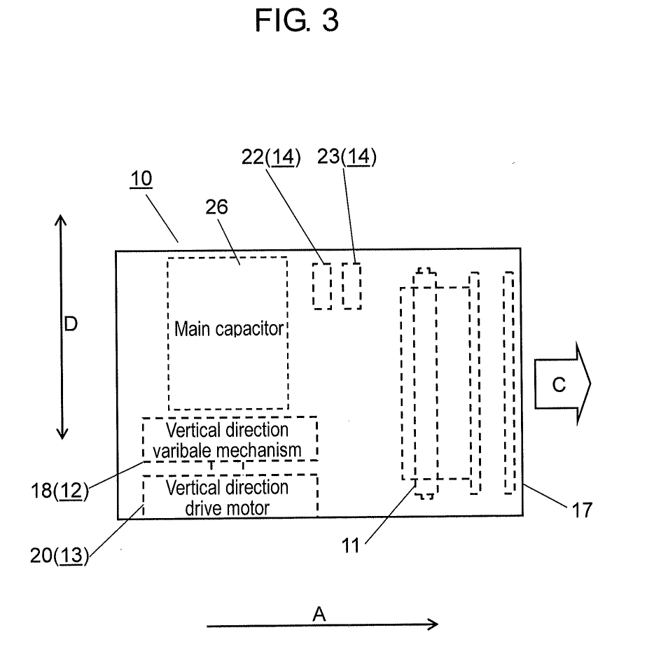

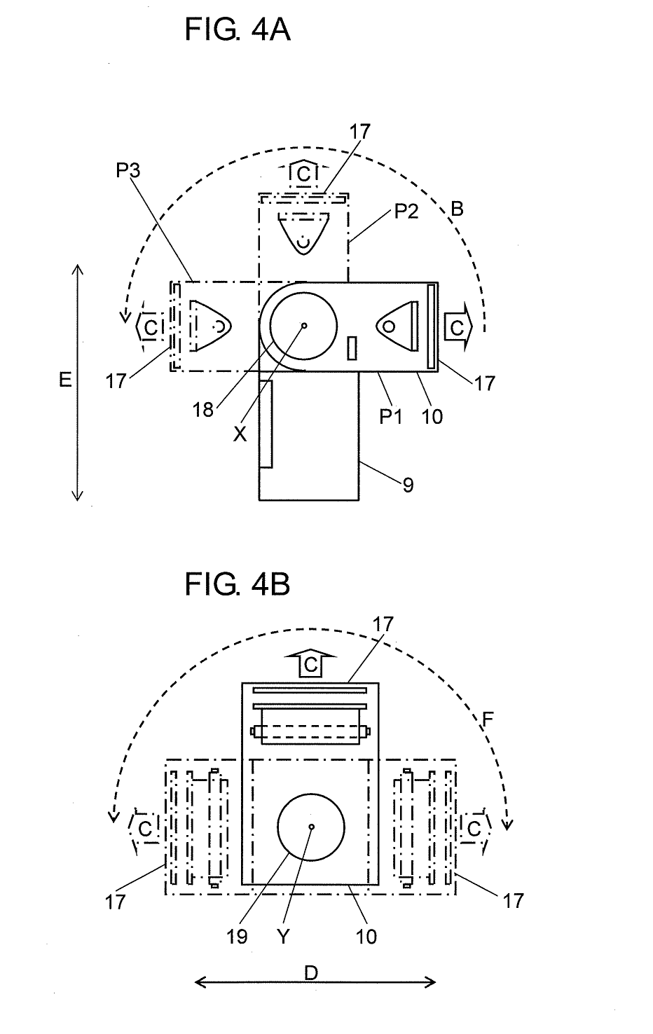

FIG. 1 is a block diagram showing a configuration of an imaging device according to an exemplary embodiment of the present invention. FIG. 2 is a side view of the strobe device according to the exemplary embodiment. FIG. 3 is a top view of the strobe device according to the exemplary embodiment. FIG. 4A is a diagram illustrating an illumination range in a vertical direction, which can be set by the strobe device according to the exemplary embodiment. FIG. 4B is a diagram illustrating an illumination range in a horizontal direction, which can be set by the strobe device according to the exemplary embodiment.

As shown in FIG. 1, imaging device 1 of the present exemplary embodiment has at least photographing function unit 3 for taking an image of a subject, control unit 4, display unit 5, operation device 6, peripheral interface (peripheral I/F) 7, and shutter 8. Further, imaging device 1 is equipped with detachable strobe device 2 for illuminating the subject by strobe light.

Control unit 4 controls strobe device 2 and photographing function unit 3. Display unit 5 displays an image obtained by shooting the subject or other images. Operation device 6 changes settings of shooting conditions and power-on/off state. Peripheral interface 7 performs input and output of image data or other data between imaging device 1 and a peripheral device. Shutter 8 is operated by a user to trigger strobe device 2 to emit light and shoot the subject.

Also, as shown in FIG. 2 and FIG. 3, strobe device 2 of the present exemplary embodiment has at least strobe main body 9 configured by a housing formed in, for example, a rectangular-shape, light-emitting unit 10, variable mechanism 12, drive unit 13, angle detection unit 14, control unit 15, and operation unit 16. Light-emitting unit 10 is rotatably connected to strobe main body 9, and has encased therein flash discharge tube 11. Light-emitting unit 10 enables flash discharge tube 11 to generate light by electric energy supplied from main capacitor 26, and emits the generated light outward. Variable mechanism 12 changes an angle of light-emitting unit 10 to a specified angle. Drive unit 13 drives variable mechanism 12. Angle detection unit 14 detects an angle of light-emitting unit 10 relative to strobe main body 9. Control unit 15 controls strobe device 2. Operation unit 16 is provided, for example, on back surface 9d of strobe main body 9, and performs input of various setting values and selection of various modes.

Also, light-emitting unit 10 is rotatably connected to strobe main body 9 at top surface 9a of strobe main body 9. In addition, strobe main body 9 is connected at lower surface 9b thereof to imaging device 1 shown in FIG. 1. At this time, strobe main body 9 is connected to imaging device 1 so that front surface 9c of strobe main body 9 faces in shooting direction A (an optical axis direction of an imaging lens) of imaging device 1.

Also, light-emitting unit 10 is configured by a housing formed, for example, in an approximately rectangular-shape (including a rectangular-shape), and is provided at one surface 10a of the housing with opening 17 for emitting light generated by flash discharge tube 11. Light-emitting unit 10 is configured so that illumination direction C in which strobe light is emitted can be changed by changing an angle of opening 17 relative to vertical direction B.

Also, variable mechanism 12 is configured, as shown in FIG. 4A and FIG. 4B, by vertical direction variable mechanism 18 and horizontal direction variable mechanism 19, and rotatably connects strobe main body 9 and light-emitting unit 10. Specifically, vertical direction variable mechanism 18 of variable mechanism 12 is connected so as to be rotatable in vertical direction B about horizontal shaft X disposed along width direction D of strobe main body 9 (see FIG. 3). On the other hand, horizontal direction variable mechanism 19 of variable mechanism 12 is connected so as to be rotatable in horizontal direction F about vertical shaft Y disposed in vertical direction E of strobe main body 9 (height direction: see FIG. 4A).

Further, vertical direction variable mechanism 18 of variable mechanism 12 is disposed, as shown in FIG. 4A, so as to be capable of changing an angle of light-emitting unit 10 in vertical direction B. Specifically, vertical direction variable mechanism 18 is disposed to rotatably connect light-emitting unit 10 with strobe main body 9 so that an angle of light-emitting unit 10 can be changed in vertical direction B within a range including a normal illumination direction angle (an angle at which light-emitting unit 10 is in normal shooting position P1 as indicated by solid lines in FIG. 4A) and a desired illumination direction angle (an angle at which light-emitting unit 10 is in bounce flash shooting position P2 or P3 as indicated by dashed lines in FIG. 4A) which is set by a user and is different from the normal illumination direction angle. In the present exemplary embodiment, vertical direction variable mechanism 18 of variable mechanism 12 is rotatable within a rotation angle range of, for example, 180 degrees in vertical direction B between normal photography position P1 and bounce flash shooting position P3.

On the other hand, horizontal direction variable mechanism 19 of variable mechanism 12 is disposed, as shown in FIG. 4B, so as to be capable of changing an angle of light-emitting unit 10 in horizontal direction F. In the present exemplary embodiment, horizontal direction variable mechanism 19 is rotatable rightward or leftward in a rotation angle range of 180 degrees.

Also, drive unit 13 has, as shown in FIG. 2 and FIG. 3, vertical direction drive unit 20 (see FIG. 3) including a vertical direction drive motor for rotationally driving vertical direction variable mechanism 18, and horizontal direction drive unit 21 (see FIG. 2) including a horizontal direction drive motor for rotationally driving horizontal direction variable mechanism 19.

Also, angle detection unit 14 is provided in light-emitting unit 10, and has vertical direction angle detection unit 22 for detecting an angle of light-emitting unit 10 in vertical direction B, and horizontal direction angle detection unit 23 for detecting an angle of light-emitting unit 10 in horizontal direction F. In the present exemplary embodiment, each of vertical direction angle detection unit 22 and horizontal direction angle detection unit 23 is configured, for example, by a potentiometer. Each of an inclination angle of light-emitting unit 10 in vertical direction B and an inclination angle of light-emitting unit 10 in horizontal direction F is detected from a voltage dependent on a rotation angle of the potentiometer.

Also, control unit 15 has arithmetic unit 24 for performing various arithmetic operations, and storage unit 25 for storing various modes and various information including continuous light emission patterns corresponding to respective modes which will be described later. Control unit 15 is configured by a CPU (Central Processing Unit), and storage unit 25 is configured by a RAM (Random Access Memory) or ROM (Read-Only Memory) incorporated in the CPU or a RAM or ROM externally connected to the CPU. The mode may include, for example, a continuous shooting mode (operation).

Strobe device 2 of the present exemplary embodiment and imaging device 1 equipped with strobe device 2 are configured as described above.

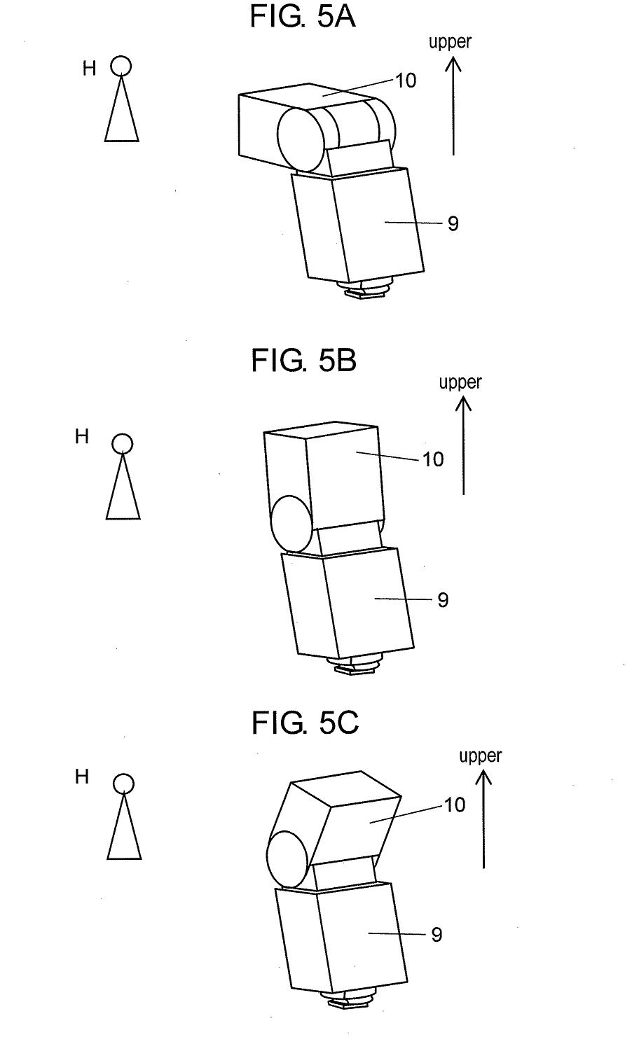

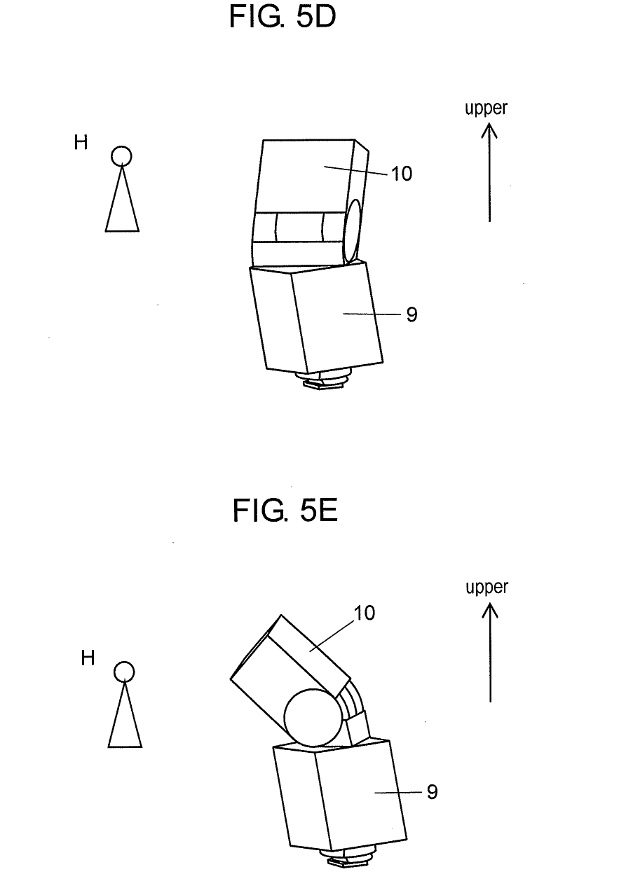

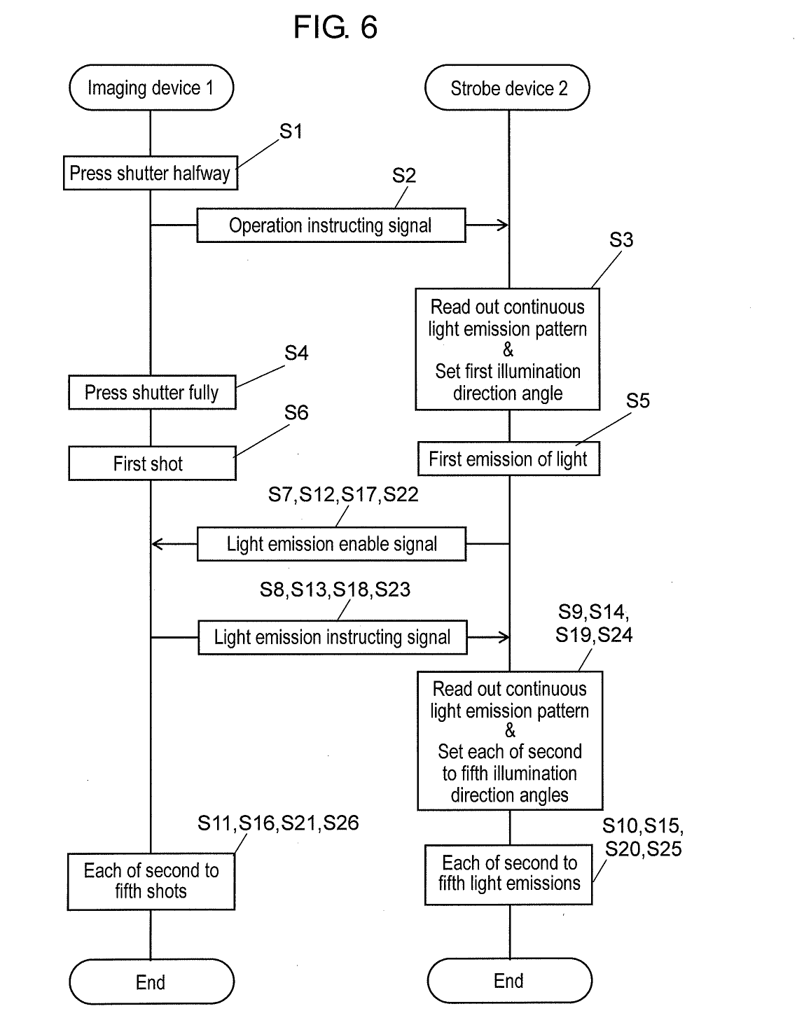

Hereinafter, operations of the imaging device according to the present exemplary embodiment in a continuous shooting mode will be described with reference to FIG. 5A to FIG. 6.

First, continuous light emission patterns in the continuous shooting mode of the imaging device according to the present exemplary embodiment will be described with reference to FIG. 5A to FIG. 5E.

Each of FIG. 5A to FIG. 5E is a conceptual diagram showing an example of continuous light emission pattern by the strobe device according to the exemplary embodiment.

The continuous shooting mode is a pattern of the so-called bracket shooting, in which the illumination direction angle of light-emitting unit 10 of strobe device 2 is changed at each shot in the continuous shooting mode.

In the present exemplary embodiment, strobe device 2 having the above-described configuration and imaging device 1 equipped with the same are used to continuously execute a plurality of shots (e.g., five shots) in response to a single pressing of shutter 8. In this operation, control unit 15 of strobe device 2 has a mode of changing the illumination direction angle of light-emitting unit 10.

That is, in response to a single pressing of shutter 8, imaging device 1 of the present exemplary embodiment performs five continuous shots in total in which strobe device 2 emits light continuously five times, while changing the illumination direction angle of light-emitting unit 10 at each shot. In order to enable light-emitting unit 10 to emit light five times within a short period of time, electrical energy of main capacitor 26 is supplied in a divisional manner.

To perform this operation, storage unit 25 of control unit 15 of strobe device 2 has stored therein five continuous light emission patterns in advance, for example, from a first illumination direction angle to a fifth illumination direction angle as shown in FIG. 5A to FIG. 5E.

Specifically, the first illumination direction angle is, as shown in FIG. 5A, an angle at which light-emitting unit 10 faces toward subject H to be photographed (subject H is illuminated directly by the strobe light). The second illumination direction angle is, as shown in FIG. 5B, an angle at which light-emitting unit 10 faces upward (light-emitting unit 10 becomes at an angle, for example, of 90 degrees upward in vertical direction B relative to strobe main unit 9). The third illumination direction angle is, as shown in FIG. 5C, an angle at which light-emitting unit 10 faces upward and away from subject H (light-emitting unit 10 becomes at an angle, for example, of 120 degrees upward in vertical direction B relative to strobe main unit 9). The fourth illumination direction angle is, as shown in FIG. 5D, an angle at which light-emitting unit 10 faces away upper rightward from subject H (light-emitting unit 10 becomes at an angle of 45 degrees rightward in horizontal direction F and at an angle of 45 degrees upward in vertical direction B relative to strobe main unit 9). The fifth illumination direction angle is, as shown in FIG. 5E, an angle at which light-emitting unit 10 faces away upper leftward from subject H (light-emitting unit 10 becomes at an angle of 45 degrees leftward in horizontal direction F and at an angle of 45 degrees upward in vertical direction B relative to strobe main unit 9).

Here, the second to fifth illumination direction angles excluding the first illumination direction angle are the illumination direction angles for providing the so-called bounce flash shooting.

Next, operations of the continuous shooting mode of the imaging device according to the present exemplary embodiment will be described with reference to FIG. 6.

FIG. 6 is a flowchart illustrating operations in the continuous shooting mode of the strobe device according to the exemplary embodiment.

As shown in FIG. 6, a photographer points an imaging lens of imaging device 1 at a subject, and presses shutter 8 halfway (step S1). In response to this operation, control unit 4 of imaging device 1 sends an operation instructing signal to strobe device 2 (step S2).

Next, control unit 15 of strobe device 2 having received the operation instructing signal reads out a continuous light emission pattern stored in storage unit 25, and selects a first illumination direction angle. According to this selection, control unit 15 of strobe device 2 changes the angle of light-emitting unit 10 relative to strobe main body 9 in vertical direction B and horizontal direction F (step S3). Specifically, control unit 15 of strobe device 2 controls vertical direction drive unit 20 and horizontal direction drive unit 21 to drive variable mechanism 12. Accordingly, each of vertical direction variable mechanism 18 and horizontal direction variable mechanism 19 change the angle of light-emitting unit 10 relative to strobe main body 9.

Next, under the condition that the angle of light-emitting unit 10 relative to strobe main body 9 is being set to the first illumination direction angle, the photographer presses shutter 8 of imaging device 1 fully (step S4). In this case, imaging device 1 sends a light emission signal (not shown) to strobe device 2.

In response to the light emission signal, control unit 15 of strobe device 2 controls light-emitting unit 10 to emit light (step S5), and at the same time, control unit 4 of imaging device 1 controls photographing function unit 3 to execute a first shot (step S6).

By the operations as described above, the first shot in the continuous light emission pattern is completed at the first illumination direction angle.

Next, control unit 15 of strobe device 2 having completed the first light emission sends, if a second light emission is possible, a light emission enable signal to imaging device 1 (step S7).

Next, control unit 4 of imaging device 1 having received the light emission enable signal sends a second light emission instructing signal to strobe device 2 (step S8).

Next, control unit 15 of strobe device 2 having received a light emission instructing signal reads out a second illumination direction angle from the continuous light emission pattern stored in storage unit 25, and sets light-emitting unit 10 to be at the second illumination direction angle (step S9).

Under the condition that the angle of light-emitting unit 10 relative to strobe main body 9 is set to the second illumination direction angle, light-emitting unit 10 is controlled to emit light (step S10). At the same time, control unit 4 of imaging device 1 controls photographing function unit 3 to execute a second shot (step S11).

By the operations as described above, the second shot in the continuous light emission pattern is completed at the second illumination direction angle.

Then, the same process as that from step S6 to step S11 is repeated until the fifth shot is completed. During this period, light-emitting unit 10 is sequentially set from the third illumination direction angle to the fifth illumination direction angle, while emission of light and shooting are performed at each angle (step S12 to step S26). As a result, a plurality of images taken at different illumination direction angles of light-emitting unit 10 can be obtained.

The photographer can obtain from the plurality of images a favorite image such, for example, as an image in which effects of the bounce flash shooting appear remarkably. Further, the photographer can obtain preferable illumination conditions of the strobe light (proper conditions concerning the illumination direction angles of light-emitting unit 10) from the obtained images.

In other words, since a plurality of images taken under different strobe illumination conditions can be obtained according to the continuous shooting mode of the present exemplary embodiment, it is possible to immediately obtain a favorite image (or preferable strobe illumination conditions).

Incidentally, in the continuous shooting mode of the present exemplary embodiment, it is not preferable that the time from the start of shooting to the end of shooting (required time for a continuous shooting) become long, because of the possibility that the state of the subject may change. Accordingly, the required time for a continuous shooting may preferably be, for example, two seconds or shorter per each continuous shooting operation.

In this respect, what accounts for the highest portion of the required time for a continuous shooting in the continuous shooting mode is the time required to change the illumination direction angle of light-emitting unit 10. Therefore, in order to shorten the required time for a continuous shooting, the time required to change the illumination direction angle of light-emitting unit 10 may be reduced.

Accordingly, in the present exemplary embodiment, vertical direction drive unit 20 and horizontal direction drive unit 21 of drive unit 13 respectively drive vertical direction variable mechanism 18 and horizontal direction variable mechanism 19 of variable mechanism 12 so that light-emitting unit 10 moves at a rate of, for example, 180° per second. This makes it possible to prevent a subject from changing in its state and to take a plurality of images in approximately a same state of the subject. As a result, it is possible to obtain from a plurality of images a favorite image such, for example, as an image in which effects of the bounce flash shooting appear remarkably. Further, the photographer can obtain preferable strobe illumination conditions (proper conditions concerning the illumination direction angle of light-emitting unit 10).

Incidentally, it may be needless to say that a strobe device of the present invention and an imaging device equipped with the same are not limited to the above-described exemplary embodiment, and that various changes may be made without departing from the scope of the present invention.

For example, in the exemplary embodiment described above, the combination of the first to fifth illumination direction angles is described as an example of the continuous light emission pattern. However, the continuous light emission pattern is not limited to this combination. For example, the continuous light emission pattern may be any appropriate combination of various illumination direction angles.

Also, in the exemplary embodiment described above, such an example is described that the number of light emissions in the continuous light emission pattern is five. However, the number of light emissions is not limited to this number. The number of light emissions may be two to four or six or more. Also, a pattern in which light is not emitted may be included as a continuous light emission pattern.

Also, in the exemplary embodiment described above, such an example is described that the number of light emissions has been set in advance. However, the present invention is not limited to this example. For example, the number of light emissions may be input by operation unit 16. This makes it possible to improve the freedom of shooting, and to improve usability.

Also, in the exemplary embodiment described above, such an example is described that the illumination direction angle of the continuous light emission pattern is changed such that both the angle in vertical direction B and the angle in horizontal direction F are changed. However, the present invention is not limited to this example. For example, the continuous light emission pattern may be designed to change only the angle in vertical direction B. This is useful to a strobe device which does not have a structure of rotating light-emitting unit 10 in horizontal direction F. Alternatively, the continuous light emission pattern may be designed to change only the angle in horizontal direction F.

Also, in the exemplary embodiment described above, such an example is described that the second to fifth illumination direction angle of the continuous light emission pattern are the angles for providing the bounce flash shooting. However, the continuous light emission pattern is not limited to this pattern. For example, the continuous light emission pattern may include only a combination of illumination direction angles which are not for providing the bounce flash shooting. Also, the continuous light emission pattern may include some illumination direction angles for providing the bounce flash shooting in a small proportion of all illumination direction angles in the continuous light emission pattern. This makes it possible to obtain a plurality of images even if a subject is directly illuminated. Also, it is possible to obtain a plurality of images under both a condition of direct flash shooting and a condition of bounce flash shooting. As a result, a favorite image can be chosen from a larger number of conditions.

Also, in the exemplary embodiment described above, such a configuration example is described that the continuous light emission pattern has been set in advance. However, the present invention is not limited to this example. For example, the continuous light emission pattern may be such a pattern that a different preferable strobe illumination condition is determined by control unit 15 of strobe device 2 at each shot, and light-emitting unit 10 emits light based on the determined condition. As an example, a plurality of bounce flash shooting operations may be executed, including, for example, a bounce flash shooting using a ceiling, a bounce flash shooting using a first surface of a wall, and a bounce flash shooting using a second surface of the wall. Then, a preferable strobe illumination condition may be determined in advance for each of the bounce flash shooting operations to set a continuous light emission pattern.

Further, for example, a preferable strobe illumination condition may be determined by control unit 15 of strobe device 2, and light-emitting unit 10 may be controlled to emit light based on this illumination condition. Then, a continuous light emission pattern may be produced by changing the determined illumination condition, being regarded as a center, in a positive direction and/or in a negative direction. As an example, if a strobe illumination condition is preferable in an illumination direction in which light-emitting unit 10 is inclined upward in vertical direction B by 45 degrees relative to strobe main body 9, a continuous light emission pattern may be produced by changing the angle of light-emitting unit 10 to, for example, 35 degrees, 40 degrees, 45 degrees, 50 degrees and 55 degrees. This makes it possible to compare images taken under illumination conditions closer to each other. As a result, a more preferable illumination condition can be obtained.

Also, in the exemplary embodiment described above, such an example of configuration is explained that strobe device 2 emits light continuously in synchronization with the light emission instructing signal continuously sent from imaging device 1. However, the present invention is not limited to this configuration. For example, if the shooting timing in the continuous shooting mode occurs at regular intervals, strobe device 2 may be configured to emit light at the same regular intervals. This may make it unnecessary to conduct communications between an imaging device such as a camera and a strobe device at each shot, and may simplify the operation.

Also, in the exemplary embodiment described above, such an example of configuration is explained that imaging device 1 executes a next shot upon receipt of a light emission enable signal from strobe device 2. However, the present invention is not limited to this configuration. For example, imaging device 1 may be configured to perform a continuous shooting without considering any information from strobe device 2. This can, similarly to the above-described configuration, make it unnecessary to conduct communication between an imaging device such as a camera and a strobe device at each shot, and can simplify the operation.

Also, in the exemplary embodiment described above, such an example is explained that electrical energy stored in main capacitor 26 of strobe device 2 is divided to power a plurality of strobe light emissions so that continuous light emissions are possible within a short period of time. However, the present invention is not limited to this example. For example, if it is desired to increase the light quantity of each of a plurality of strobe light emissions in a continuous light emission mode, emission interval of the continuous light emissions may be extended, or shooting interval in the continuous shooting mode may be extended. This may be responded by increasing the time for charging main capacitor 26 with electrical energy in the emission interval.

Also, in the exemplary embodiment described above, such an example is explained that the angle of light-emitting unit 10 is controlled by using an absolute angle in vertical direction B detected by vertical direction angle detection unit 22 and an absolute angle in horizontal direction F detected by horizontal direction angle detection unit 23. However, the present invention is not limited to this example. For example, the angle of light-emitting unit 10 may be controlled by relatively changing the angles of light-emitting unit 10 in vertical direction B and horizontal direction F depending on control amounts of vertical direction drive unit 20 and horizontal direction drive unit 21 or driven amounts of vertical direction variable mechanism 18 and horizontal direction variable mechanism 19. It is possible to eliminate vertical direction angle detection unit 22 and horizontal direction angle detection unit 23. As a result, it is possible to reduce cost of the strobe device and imaging device 1.

Also, in the exemplary embodiment described above, such an example is explained that five continuous shots are executed in response to a single press of shutter 8 in the continuous shooting mode. However, the present invention is not limited to this example. For example, such a continuous shooting mode may be possible that requires pressing of shutter 8 for each shot in a continuous shooting mode. This makes it possible to take continuous images by an imaging device such as a camera which does not have a continuous shooting mode.

As described herein above, a strobe device according to the present invention includes: a strobe main body; a light-emitting unit rotatably connected to the strobe main body; a variable mechanism capable of changing an angle of the light-emitting unit; a drive unit for driving the variable mechanism; and a control unit for controlling the drive unit, wherein the control unit has a mode of changing an illumination direction angle of the light-emitting unit at each shot in a continuous shooting operation.

With this configuration, the illumination direction angle of the light-emitting unit can be changed by changing the angle of the light-emitting unit relative to the strobe main body. When the imaging device takes continuous images of a subject within a short time in a mode in which the illumination direction angle of the light-emitting unit is to be changed at each shot, the control unit changes the angle of the light-emitting unit to change the illumination direction of the light-emitting unit at each shot. This makes it possible to obtain a plurality of images of the subject in nearly a same state under different strobe illumination conditions. As a result, a photographer can easily obtain a favorite image from the plurality of images, such, for example, as an image in which effects of the bounce flash shooting appear remarkably. Further, the photographer can obtain preferable strobe illumination conditions.

Also, according to the strobe device of the present invention, the mode may include shots at a plurality of illumination direction angles with different strobe illumination conditions for bounce flash shooting.

In this configuration, it is possible to obtain a plurality of images taken by the bounce flash shooting under different strobe illumination conditions. As a result, a photographer can easily obtain a favorite image from the plurality of images, such, for example, as an image in which effects of the bounce flash shooting appear favorably. Further, the photographer can obtain preferable strobe illumination conditions for bounce flash shooting.

Also, according to the strobe device of the present invention, the mode may include a change of the angle of the light-emitting unit relative to the strobe main body in at least one of the vertical direction and the horizontal direction.

In this configuration, it is possible to obtain a plurality of images taken under strobe illumination conditions which are different from one another in at least one of the vertical direction and the horizontal direction. As a result, a photographer can easily obtain a favorite image from the plurality of images. Further, the photographer can obtain preferable strobe illumination conditions in at least one of the vertical direction and the horizontal direction.

Also, an imaging device according to the present invention may be equipped with the above-described strobe device. This makes it possible to realize an imaging device that can easily obtain a plurality of images taken under different strobe illumination conditions.

### INDUSTRIAL APPLICABILITY

The present invention is useful to a strobe device and an imaging device equipped with the strobe device which are required to immediately obtain a favorite image (or preferable strobe illumination conditions) in case of continuously taking images.

### REFERENCE MARKS IN THE DRAWINGS

1 imaging device

2 strobe device

3 photographing function unit

4 control device

5 display unit

6 operation device

7 peripheral interface

8 shutter

9 strobe main body

9a upper surface

9b lower surface

9c front surface

9d back surface

10 light-emitting unit

10a one surface

11 flash discharge tube

12 variable mechanism

13 drive unit

14 angle detection unit

15 control unit

16 operation unit

17 opening

18 vertical direction variable mechanism

19 horizontal direction variable mechanism

20 vertical direction drive unit

21 horizontal direction drive unit

22 vertical direction angle detection unit

23 horizontal direction angle detection unit

24 arithmetic unit

25 storage unit

26 main capacitor

1. A strobe device comprising:
a strobe main body;
a light-emitting unit rotatably connected to the strobe main body;
a variable mechanism capable of changing an angle of the light-emitting unit;
a drive unit for driving the variable mechanism; and
a control unit for controlling the drive unit,
wherein the control unit has a mode of changing an illumination direction angle of the light-emitting unit at each shot in a continuous shooting operation.

2. The strobe device according to claim 1, wherein the mode includes shots at a plurality of illumination direction angles with different strobe illumination conditions for bounce flash shooting.

3. The strobe device according to claim 1, wherein the mode includes a change of the angle of the light-emitting unit relative to the strobe main body in at least one of a vertical direction and a horizontal direction.

4. An imaging device comprising the strobe device according to claim 1.

5. The strobe device according to claim 2, wherein the mode includes a change of the angle of the light-emitting unit relative to the strobe main body in at least one of a vertical direction and a horizontal direction.

6. An imaging device comprising the strobe device according to claim 2.

7. An imaging device comprising the strobe device according to claim 3.

8. An imaging device comprising the strobe device according to claim 5.
